(19) United States
(12) Patent Application Publication
(10) Pub. No.: US 2024/0379985 A1
(43) Pub. Date: Nov. 14, 2024

(54) FUEL CELL WET END WITH TERMINAL-COMPRESSION PLATE

(71) Applicant: GM GLOBAL TECHNOLOGY OPERATIONS LLC, Detroit, MI (US)

(72) Inventors: Ronald Miller, Bloomfield Hills, MI (US); Bhaskara K. Ch, near Rajamundury (IN); Brian Miller, Royal Oak, MI (US); Abhishek Kumar Sahu, Bengaluru (IN)

(73) Assignee: GM GLOBAL TECHNOLOGY OPERATIONS LLC, Detroit, MI (US)

(21) Appl. No.: 18/314,415

(22) Filed: May 9, 2023

(51) Int. Cl. H01M 8/248; H01M 8/2483; H01M 8/2485

(52) U.S. Cl. CPC H01M 8/248; H01M 8/2483; H01M 8/2485

(57) ABSTRACT

A fuel cell system includes a dry end unit, a wet end unit comprising a terminal-compression plate, an insulator plate, and a base plate, and a plurality of fuel cells disposed between the dry end unit and the wet end unit. Each of the plurality of fuel cells includes a perimeter area that surrounds the plurality of fuel cells. The terminal-compression plate functions as a compression plate and a terminal plate, and where the base plate is used to uniformly compress the plurality of fuel cells through the insulator plate and the terminal-compression plate.

### INTRODUCTION

Fuel cells are a type of electrochemical cell that convert the chemical energy of a fuel and an oxidizing agent into electricity through a chemical reaction. Fuel cells are widely used in various applications, such as transportation, power generation, and portable devices. However, the construction of fuel cells can be complex, which limits their widespread adoption.

The present disclosure is related to fuel cell systems and more specifically, to the wet end design of fuel cell stack in a Polymer Electrolyte Membrane (PEM) fuel cells (also called proton exchange membrane). These types of fuel cells typically have a polymer as the electrolyte and pair of porous carbon electrodes containing platinum or platinum alloy catalyst. It requires hydrogen gas (supplied from storage tank), oxygen from the air, and water to operate. In a PEM fuel cell, the fuel, typically hydrogen gas, may be supplied to the anode, while the oxidant, typically oxygen or air, may be supplied to the cathode. The electrolyte, which is typically polymer, sits between the two electrodes and allows ions (protons) but not to electrons to pass through it, completing the circuit and generating electricity.

One advantage of PEM fuel cells is that they can operate at relatively low temperatures, which can increase efficiency. However, they also require careful management of the electrolyte, which can be corrosive and may require replacement over time. Additionally, PEM fuel cells may be more prone to leaks or other issues due to the presence of various fluids.

What is desired is a design for a wet end of the PEM fuel cell stack that is resistant to the working liquid, simplified design and construction, and sufficiently stiff components to generate uniform compression in the cells of the stack.

### SUMMARY

Disclosed herein are a fuel cell system, a wet end unit for a fuel cell, and a fuel cell apparatus. As disclosed herein, a fuel cell system including a dry end unit, a wet end unit including a terminal-compression plate, an insulator plate, and a base plate. The system may also include a plurality of fuel cells disposed between the dry end unit and the wet end unit, wherein each of the plurality of fuel cells may include a perimeter area that surrounds the plurality of fuel cells. Furthermore, the terminal-compression plate may function as a compression plate and a terminal plate, and where the base plate may uniformly compress the plurality of fuel cells through the insulator plate and the terminal-compression plate.

Another aspect of the disclosure may be a system that includes a plurality of manifolds, where each of the plurality of manifolds is configured to bolt to the base plate.

Another aspect of the disclosure may be a system having the insulator plate isolated from a working fluid within the fuel cell system.

Another aspect of the disclosure may be a system in which the terminal-compression plate provides for passage of a working fluid.

Another aspect of the disclosure may be a system where the terminal-compression plate may include one or more bolt hole provisions for a bus bar clamping attachment.

Another aspect of the disclosure may be a system where the terminal-compression plate may include an electroless nickel plated aluminum alloy.

Another aspect of the disclosure may be a system where the insulator plate gives passage to a plurality of manifolds and contains no metallic inserts.

Another aspect of the disclosure may be a system where a plurality of manifolds may be sealed to the terminal-compression plate utilizing one or more push in place seals.

Another aspect of the disclosure may be a system including a plurality of manifolds that may be configured for a uniform entry and exit of fuel, air, and coolant, to the plurality of fuel cells.

As disclosed herein, a wet end unit for a fuel cell may include a terminal-compression plate, an insulator plate, and a base plate. The terminal-compression plate within the wet end unit may function as a compression plate and a terminal plate, and where the base plate may uniformly compress a plurality of fuel cells through the insulator plate and the terminal-compression plate.

Another aspect of the disclosure may be a wet end unit that includes a plurality of manifolds, where each of the plurality of manifolds may bolt to the base plate.

Another aspect of the disclosure may be a wet end unit where the insulator plate may be isolated from a working fluid.

Another aspect of the disclosure may be a wet end unit where the terminal-compression plate may provide for passage of a working fluid.

Another aspect of the disclosure may be a wet end unit where the terminal-compression plate may include one or more bolt hole provisions for a bus bar clamping attachment.

Another aspect of the disclosure may be a wet end unit where the terminal-compression plate may include an electroless nickel plated aluminum alloy.

Another aspect of the disclosure may be a wet end unit where the insulator plate may give passage to a plurality of manifolds and contain no metallic inserts.

Another aspect of the disclosure may be a wet end unit where a plurality of manifolds may be sealed to the terminal-compression plate utilizing one or more push in place seals.

Another aspect of the disclosure may be a wet end unit that includes a plurality of manifolds that may include a uniform entry and exit for fuel, air, and coolant, to the plurality of fuel cells.

Another aspect of the disclosure may be a wet end unit where the plurality of manifolds may include a plurality of groves for push in place seal placement.

As disclosed herein, a fuel cell apparatus may include a dry end unit, a wet end unit including a terminal-compression plate, an insulator plate, and a base plate. The apparatus may also include a plurality of fuel cells disposed between the dry end unit and the wet end unit, where each of the plurality of fuel cells may include a perimeter area that surrounds the plurality of fuel cells. The apparatus may also include a plurality of manifolds that may provide for a uniform entry and exit of fuel, air, and coolant, to the plurality of fuel cells, and where each of the plurality of manifolds may bolt to the base plate. Further, the terminal-compression plate may function as a compression plate and a terminal plate, and where the base plate may uniformly compress the plurality of fuel cells through the insulator plate and the terminal-compression plate. Further, the insulator plate may be isolated from a working fluid within the fuel cell apparatus, and the terminal-compression plate may provide for passage of the working fluid. The terminal-compression plate may include one or more bolt hole provisions for a bus bar clamping, and where the terminal-compression plate may include an electroless nickel plated aluminum alloy. And where the insulator plate may give passage to the plurality of manifolds and contain no metallic inserts, and where the plurality of manifolds may be sealed to the terminal-compression plate utilizing one or more push in place seals.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIGS. 1A and 1B are illustrations of a PEM fuel cell stack, in accordance with the disclosure.

FIGS. 2A and 2B are illustrations of wet end configurations in a fuel cell stack, in accordance with the disclosure.

FIG. 3 are illustrations of manifolds, insulator plates and compression plates of a fuel cell wet end, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

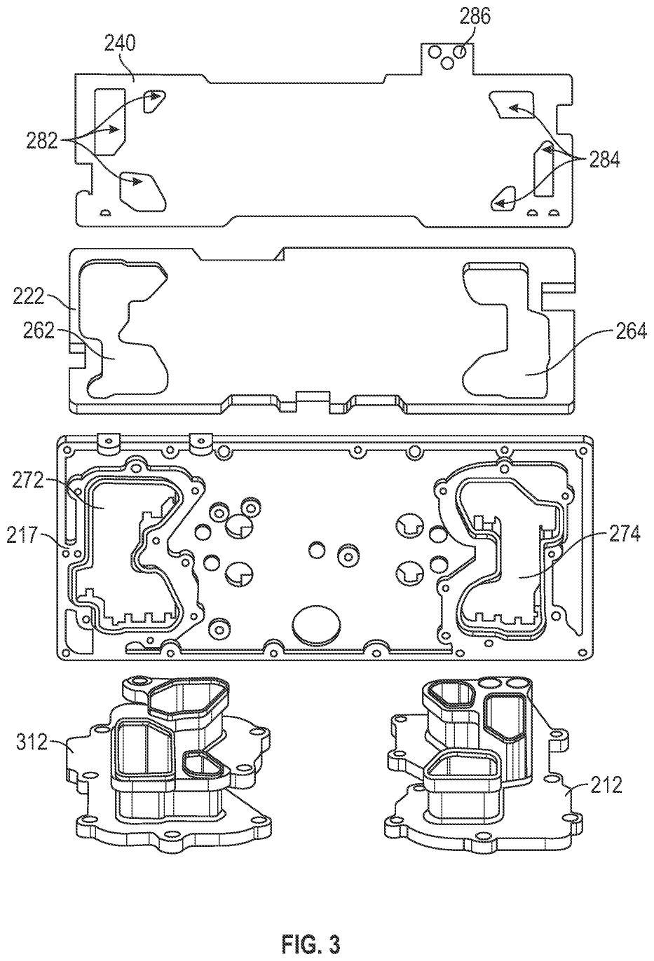

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

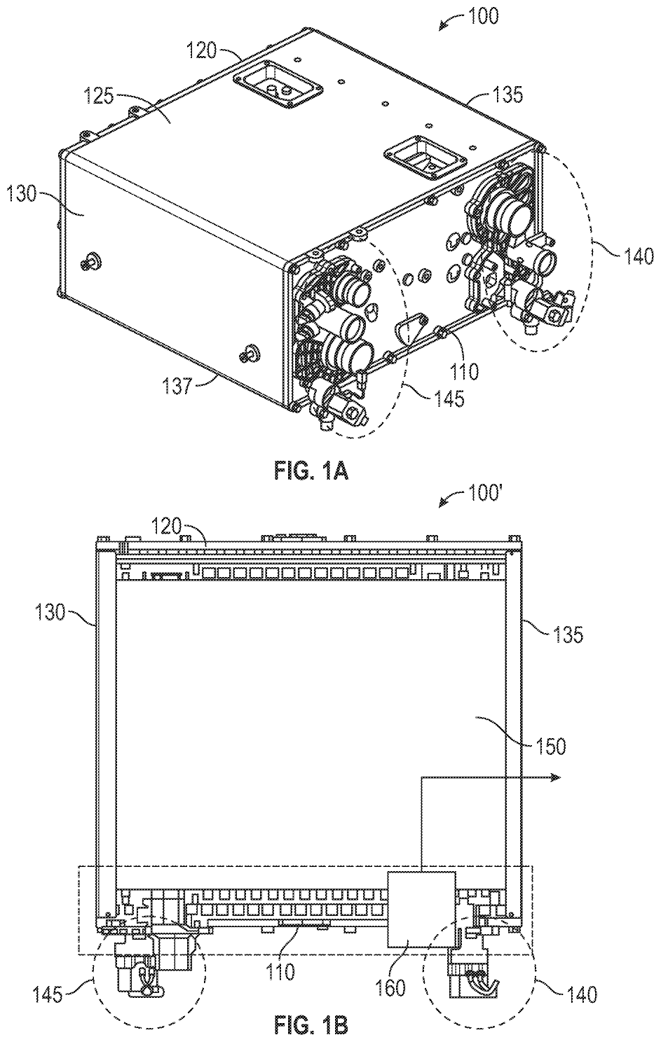

Referring to FIGS. 1A and 1B, which are illustrations of a PEM fuel cell system 100 and 100′ respectively, according to an embodiment of the present disclosure. FIG. 1A illustrates a perspective diagram of an example implementation of a PEM fuel cell system 100. System 100 may include a wet end 110, which may also be referred to as a wet end unit or assembly. The wet end 110 may be designed to receive fluids, coolant, and exhaust byproducts, e.g., working fluids, of the fuel cell stack 150 (shown in FIG. 1B) from the system 100 through couplings 140 and couplings 145. At the opposite end of the fuel system 100 is the dry end 120, which may also be referred to as a dry end unit or assembly. System 100 may also include multiple sidewalls, shown are sidewall 125, sidewall 130, and hidden are sidewall 135 and sidewall 137. The sidewalls are generally operational to provide mechanical support and an environmental seal around the fuel cells. In various embodiments, the sidewalls 125, 130, 135, and 137 may be attached to the dry end 120 and the wet end 110. Attachment may be implemented with bolts. Other attachment techniques may be implemented to meet the design criteria of a particular application.

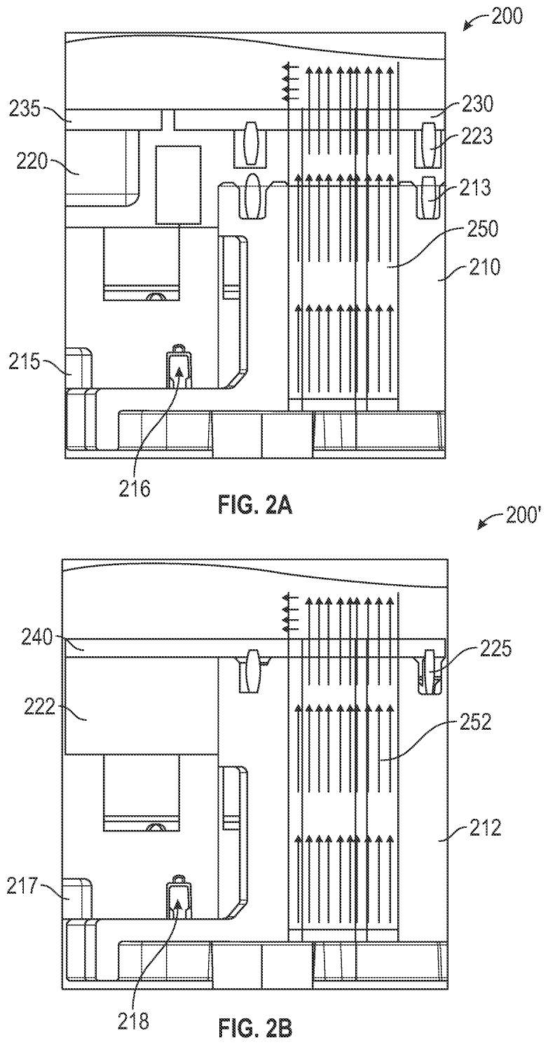

FIG. 1B is a side view illustration of a PEM fuel cell system 100′, according to an embodiment of the present disclosure. System 100′ is illustrated with sidewall 125 removed. System 100′ further illustrates the placement of the wet end 110, the dry end 120, couplings 140, couplings 145, sidewall 130, and sidewall 135. Between the wet end 110 and the dry end 120 are where the fuel cell stack 150 may be positioned. Further shown is section 160 that is further enlarged and will be discussed in FIG. 2A and FIG. 2B.

FIGS. 2A and 2B, are illustrations of a fuel cell wet end 200 and 200′ respectively, according to an embodiment of the present disclosure. FIG. 2A and FIG. 2B illustrate section 160 from FIG. 1B of the wet end portion of the PEM fuel system 100′.

FIG. 2A illustrates an embodiment of a wet end design of fuel cell design primarily directed to the use of a manifold 210, a base plate 215, an insulator plate 220, a compression plate 230, and a terminal plate 235, according to an embodiment of the present disclosure. For example, manifold 210 may be designed to receive fluids and exhaust byproducts of the fuel cell stack 150 through coupling 140. The fuels, exhaust byproducts, coolants and other applicable products may also be collectively referred to as a working fluid is shown as working fluid 250 that may flow through manifold 210, insulator plate 220, and compression plate 230. In addition, manifold 210 may be connected to the base plate 215 through the use of a push in place seal 216. Manifold 210 may also be connected to the insulator plate 220 through the use of a push in place seal 213. The insulator plate 220 may also be coupled to the compression plate 230 through the use of a push in place seal 223.

Compression plate 230 may be used to generate a uniform compression in the cells in a stack, for example in fuel cell stack 150. In the same plane as compression plate 230 is terminal plate 235 that may be used to collect a generated electrical charge from the fuel cell stack 150.

Insulator plate 220 may also separate manifold 210 from terminal plate 235 and also may utilize a push in place seal, not shown, to couple the insulator plate 220 to the terminal plate 235.

FIG. 2B illustrates an embodiment of a wet end design of fuel cell design primarily directed to the use of a manifold 212, a base plate 217, an insulator plate 222, and a terminal-compression plate 240, according to an embodiment of the present disclosure. FIG. 3 is an illustration of the right manifold 212, base plate 217, insulator plate 222, and terminal-compression plate 240 of FIG. 2A, according to an embodiment of the present disclosure. FIG. 3 also illustrates a left manifold 312.

Terminal-compression plate 240 replaces the terminal plate 235 and compression plate 230 of FIG. 2A. Terminal-compression plate 240, as a single piece eliminates a potential gap or failure point between terminal plate 235 and compression plate 230, thereby potentially reducing a risk of leakage of the working fluid 252.

Terminal-compression plate 240 may provide rigid support and electrical current collection as a single component. Terminal-compression plate 240 may be manufactured using an aluminum alloy that may also be electroless nickel plated, thereby reducing the use of heavier elements such as stainless steel. The single component terminal-compression plate 240 thereby may function as a terminal plate, a compression plate, a passage for working fluids, and also may include bolt hole provisions 286 for bus bar clamping as shown in FIG. 3. The terminal-compression plate 240 may contain no welds, no formed shape, and manufactured from industry grade plating, for example 4.75 mm plate. Further, terminal-compression plate 240 may also include openings 282 and 284 for the uniform entry and exit of fuel, air, and coolant throughout the fuel cells, for example, the fuel cell stack 150. Note that the left manifold 312 and the right manifold 212 may be coupled to terminal-compression plate 240, for example using push in place seal 225, but may not pass physically through terminal-compression plate 240. In addition, manifold 212 may be connected the base plate 217 through the use of a push in place seal 218.

Insulator plate 222, which may be coupled to terminal-compression plate 240 and base plate 217, is physically isolated from the working fluid 252 as the working fluid 252 is contained within the right manifold 212 and the left manifold 312. While insulator plate 222 may not interact with the working fluid 252, but gives passage to the right manifold 212 and the left manifold 312 through cutout 262 and cutout 264.

Further, insulator plate 222 may also contain no metallic inserts and may also be manufactured without ribbing supports in a uniform section. As a result of not interacting with the working fluid 252, the insulator plate 222 eliminates a need to seal the insulator plate 222 from the working fluid 252. In addition, without ribbing, the insulator plate 222 may maintain a high degree of flatness that may be achieved in production. In an embodiment, insulator plate 222 may include the use of a glass filled polyetherimide.

Base plate 217 may be sufficiently stiff to generate a uniform compression in the cells in the stack, for example in fuel cell stack 150. Further, base plate 217 may be made of aluminum, possibly by a sand cast process. Further, base plate 217 may also include passage to the right manifold 212 and the left manifold 312 through cutout 272 and cutout 274. In addition, right manifold 212 and the left manifold 312 may be bolted to base plate 217. Further, base plate 217 may be used to uniformly compress a plurality of fuel cells through the insulator plate and the terminal-compression plate.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A fuel cell system comprising:
a dry end unit;
a wet end unit comprising a terminal-compression plate, an insulator plate, and a base plate; and
a plurality of fuel cells disposed between the dry end unit and the wet end unit, wherein each of the plurality of fuel cells includes a perimeter area that surrounds the plurality of fuel cells,
wherein the terminal-compression plate functions as a compression plate and a terminal plate, and
wherein the base plate is configured to uniformly compress the plurality of fuel cells through the insulator plate and the terminal-compression plate.

2. The fuel cell system of claim 1, further comprising a plurality of manifolds, wherein each of the plurality of manifolds is configured to bolt to the base plate.

3. The fuel cell system of claim 1, wherein the insulator plate is isolated from a working fluid within the fuel cell system.

4. The fuel cell system of claim 1, wherein the terminal-compression plate provides for passage of a working fluid.

5. The fuel cell system of claim 1, wherein the terminal-compression plate includes one or more bolt hole provision configured for a bus bar clamping.

6. The fuel cell system of claim 1, wherein the terminal-compression plate comprises an electroless nickel plated aluminum alloy.

7. The fuel cell system of claim 1, wherein the insulator plate gives passage to a plurality of manifolds and contains no metallic inserts.

8. The fuel cell system of claim 1, wherein a plurality of manifolds are sealed to the terminal-compression plate utilizing one or more push in place seals.

9. The fuel cell system of claim 1, further comprising a plurality of manifolds that are configured for a uniform entry and exit of fuel, air, and coolant, to the plurality of fuel cells.

10. A wet end unit for a fuel cell comprising:
a terminal-compression plate;
an insulator plate; and
a base plate;
wherein the terminal-compression plate functions as a compression plate and a terminal plate, and
wherein the base plate is configured to uniformly compress a plurality of fuel cells through the insulator plate and the terminal-compression plate.

11. The wet end unit for a fuel cell of claim 10, further comprising a plurality of manifolds, wherein each of the plurality of manifolds is configured to bolt to the base plate.

12. The wet end unit for a fuel cell of claim 10, wherein the insulator plate is isolated from a working fluid.

13. The wet end unit for a fuel cell of claim 10, wherein the terminal-compression plate provides for passage of a working fluid.

14. The wet end unit for a fuel cell of claim 10, wherein the terminal-compression plate includes one or more bolt hole provision configured for a bus bar clamping.

15. The wet end unit for a fuel cell of claim 10, wherein the terminal-compression plate comprises an electroless nickel plated aluminum alloy.

16. The wet end unit for a fuel cell of claim 10, wherein the insulator plate gives passage to a plurality of manifolds and contains no metallic inserts.

17. The wet end unit for a fuel cell of claim 10, wherein a plurality of manifolds are sealed to the terminal-compression plate utilizing one or more push in place seals.

18. The wet end unit for a fuel cell of claim 10, further comprising a plurality of manifolds that are configured for a uniform entry and exit of fuel, air, and coolant, to the plurality of fuel cells.

19. The wet end unit for a fuel cell of claim 18, wherein the plurality of manifolds comprises a plurality of groves for push in place seal placement.

20. A fuel cell apparatus comprising:
a dry end unit;
a wet end unit comprising a terminal-compression plate, an insulator plate, and a base plate;
a plurality of fuel cells disposed between the dry end unit and the wet end unit, wherein each of the plurality of fuel cells includes a perimeter area that surrounds the plurality of fuel cells; and
a plurality of manifolds, configured for a uniform entry and exit of fuel, air, and coolant, to the plurality of fuel cells, wherein each of the plurality of manifolds is configured to bolt to the base plate;
wherein the terminal-compression plate functions as a compression plate and a terminal plate,
wherein the base plate is configured to uniformly compress the plurality of fuel cells through the insulator plate and the terminal-compression plate,
wherein the insulator plate is isolated from a working fluid within the fuel cell apparatus,
wherein the terminal-compression plate provides for passage of the working fluid,
wherein the terminal-compression plate includes one or more bolt hole provisions configured for a bus bar clamping,
wherein the terminal-compression plate comprises an electroless nickel plated aluminum alloy,
wherein the insulator plate gives passage to the plurality of manifolds and contains no metallic inserts,
wherein the plurality of manifolds is sealed to the terminal-compression plate utilizing one or more push in place seals.
